(19) United States
(12) Patent Application Publication
(10) Pub. No.: US 2008/0264457 A1
(43) Pub. Date: Oct. 30, 2008

(54) Substrate Treatment Apparatus

(75) Inventors: Yoshikazu Iida, Oume-shi (JP); Masayuki Bouno, Asakuchi-gun (JP); Makoto Kobayashi, Oume-shi (JP); Eietsu Soneta, Iruma-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: S.E.E. CO., LTD., TOKYO (JP)

(21) Appl. No.: 11/661,654

(22) PCT Filed: May 23, 2005
(86) PCT No.: PCT/JP2005/009332

§ 371 Date: Oct. 30, 2007

(30) Foreign Application Priority Data
Sep. 16, 2004 (JP) 2004-270578

(51) Int. Cl. B08B 13/00

(52) U.S. Cl. 134/153

(57) ABSTRACT

A substrate treatment apparatus (1) capable of performing the surface treatment of a treated substrate (W) by placing the treated substrate on a substrate support body (2) and dripping a treatment liquid on the surface of the substrate while rotating the substrate support body (2). The substrate support body (2) comprises a circular casserole-like base (3), a top board (10) generally formed in a disk shape, having a longitudinal cross section of reverse trapezoidal shape, and fitted to the upper opening of the base, and a hollow rotating shaft (15) fitted to the base (3) or the top board (10) at its rotating axis. The apparatus is characterized in that a gas blowout nozzle (14) comprising a plurality of slit-like grooves radially extending from the hollow rotating shaft (15) to the outside is formed in at least one surface selected from the contact surface (13) of the top board (10) and the upper opening contact surface (5a) of the base (3) brought into contact with each other by the fitting. Thus, the substrate treatment apparatus having the substrate support body can be easily assembled by eliminating the need of adjusting the gas blowout nozzle in assembling.

### FIELD OF THE INVENTION

The present invention relates to a substrate treatment apparatus capable of performing surface treatment on a variety of substrates such as semiconductor wafers, liquid crystal display substrates, recording disk substrates, or mask substrates. More particularly, the present invention relates to a substrate treatment apparatus with an improved support body on which a a substrate to be treated is placed.

### RELATED ART

A substrate treatment apparatus capable of performing surface treatment on a variety of substrates such as semiconductor wafers, liquid crystal display substrates, recording disk substrates, or mask substrates can be classified into two different types based on its processes: a so-called batch process and a single-wafer process.

The substrate treatment apparatus using the batch process processes a number of substrates to be treated such as semiconductor wafers (hereinafter, collectively referred to as “wafers”) set into a cassette in bulk by immersing the cassette into a treatment liquid stored in a treatment tank. The apparatus is capable of processing large numbers of wafers at one time.

The substrate treatment apparatus using the single-wafer process processes one wafer placed on its table at a time, by rotating the table and dripping a treatment liquid on a wafer surface. As the wafer is processed one by one, mutual contamination between wafers can be avoided. Furthermore, the treatment liquid to be used may be relatively small in amount.

However, the substrate treatment apparatus using the above-described single-wafer process needs to process, for example, clean one surface of a wafer and then reverse the wafer to clean the other side. This presents a problem in that a cleaned surface may be contaminated by cleaning liquid containing impurities because the cleaning liquid may go around to the other side while one surface is cleaned. However, a substrate treatment apparatus to solve the problem has been developed and disclosed in related art (for example, refer to Patent Document 1).

FIG. 4 is a sectional view showing a substrate support body of the substrate treatment apparatus disclosed in Patent Document 1. This substrate support body 100 comprises a pot-like bottom portion 102 and a rotation-symmetrical top portion 101 with a space (circular nozzle) 103 to exhaust gas therebetween.

The circular nozzle 103 is formed so as to have an acute angle to a top end surface of the substrate support body 100, in between boundary walls formed by the top portion 101 and the bottom portion 102.

The gas supplied to the circular nozzle 103 is supplied from a gas supply source (not shown), through a hollow shaft 104 and a plurality of radial holes 105. By supplying the gas, the cleaning liquid dripped to one surface of a substrate to be treated W is made not to go around to the other side while the substrate to be treated W is being cleaned.

Among such substrate support bodies, one which can adjust a gap of a circular nozzle is also known (for example, refer to Patent Document 2).

FIG. 5 is a sectional view showing a substrate support body disclosed in Patent Document 2. As the apparatus has similar features to the above-described substrate support body 100, common portions are denoted by the same reference numerals, and descriptions thereof will be omitted.

This substrate support body 100′ interposes a space ring 106 between the top portion 101 and the bottom portion 102 and makes it possible to adjust a gap formed between the portion 101 and the portion 102 by the space ring 106, in other words, the circular nozzle 103.

According to such features, by adjusting the gap of the circular nozzle, the cleaning liquid dripped to one surface of the substrate W can be adjusted not to go around to the other side while the substrate to be treated W is being cleaned.

### [Patent Document 1]

JP-5-14791-B (FIG. 1, from the right column of page 4, line 18 to the left column of page 5, line 22)

### [Patent Document 2]

JP-11-515139-T (FIG. 3, page 9 lines 10 to 25)

### DISCLOSURE OF THE INVENTION

### Problems to be Solved

The gap of the circular nozzle disclosed in Patent Document 1 and Patent Document 2 plays an important role in preventing the cleaning liquid dripped to one surface of the substrate W from going around to the other side while the substrate to be treated W is being cleaned. In other words, in order to prevent the cleaning liquid dripped to one substrate surface from going around to the other side while the substrate is being cleaned, the gas needs to be sprayed stably and evenly from the circular nozzle. For this end, the gap of the circular nozzle must be kept in a constant state.

In order to keep the gap of the circular nozzle constant, precise surface processing needs to be performed to counter surfaces of the portion 101 and the portion 102. Further, a support mechanism is required to support and fix the two portions so as to keep the gap between the portions constant. However, such surface processing and assembly demand high level of technologies, and it is extremely difficult to keep the gap constant. Even the gap is kept constant during assembly, it may change while the apparatus is operated, causing problems to processing.

The substrate support body disclosed in Patent Document 2 is provided with a gap adjusting means enabling the adjustment of a gap space. But a special member is required for the adjusting means, whereby even with such an adjusting means, the adjustment is not easy.

In addition, substrates to be treated such as semiconductor wafers have become large in diameter. To process a wafer with a diameter of 300 mm and more, further high-quality treatment is demanded. To satisfy the demand, it has become increasingly important to keep the gap of the above-described circular nozzle constant. Therefore, it is difficult to comply with these demands when the support body of the apparatus treating substrates that are relatively small in diameter is used as it is.

In view of the above-described problems in related art, an advantage of the present invention is to provide a substrate treatment apparatus comprising a substrate treatment body which can be easily assembled without the need of adjusting a blowout nozzle in assembling.

### Means to Solve the Problems

(1) To obtain the above advantage, according to an aspect of the present invention, a substrate treatment apparatus includes a substrate support body on which a substrate to be treated is placed for performing surface treatment by dripping a treatment liquid on a surface of the substrate while rotating the substrate support body. The substrate support body comprises a circular bowl-shaped base, a top board generally formed in a disk shape, having a longitudinal cross section of reverse trapezoidal shape, and fitted to an upper opening of the base, and a hollow rotating shaft provided to the base or the top board at its rotating axis. A gas blowout nozzle comprising a plurality of slit-like grooves radially extending from the hollow rotating shaft to the outside is formed in at least one surface selected from a contact surface of the top board and an upper opening contact surface of the base brought into contact with each other by the fitting.

(2) According to the aspect (1), the slit-like grooves are preferably formed with any one of a concave groove, a semicircle groove or a square groove having a predetermined width and depth.

(3) According to the aspect (2), the slit-like grooves are preferably formed with a first groove and a second groove having different widths or depths, and the first and second grooves are arranged alternatively.

(4) According to the aspect (1), the substrate support body is preferably a substrate support pin of a predetermined height raised on a surface of the base on which the substrate to be treated is placed.

### ADVANTAGES OF THE INVENTION

By providing the features stated above, the present invention offers advantages as hereinafter described. As the gas blowout nozzle is formed by slit-like grooves provided in at least one surface selected from the contact surface of the top board and the upper opening contact surface of the base, a gas guide passage can be formed by fitting the top board to the opening of the base. Therefore, there is no need to form a gap by fitting a top board to an opening of a base in a facing manner with a predetermined space within the opening as in the related art. Also, as the support mechanism is not necessary, the assembly of the substrate support body becomes extremely easy.

An amount of gas blown out from the gas blowout nozzle is determined by the shape of the slit-like grooves. As there is no need to adjust the gap as in the related art, and a constant amount of gas can be blown out evenly, the treatment liquid does not go around to an untreated substrate surface (reverse side) during operation. By changing the number and shape of the grooves, the amount of blowout can be modified depending on a variety of treatment specifications of the substrate to be treated.

As the gas blowout nozzle is formed with slit-like grooves, the nozzle can be formed extremely easily.

According to the preferred aspect of the present invention, by forming the slit-like grooves with any one of a concave groove, a semicircle groove or a square groove having a predetermined width and depth, the blowout nozzle can be formed extremely easily as molding of the groove and the like can be performed with ease.

As an amount of gas blown out is determined by the shape of these slit-like grooves, by changing the number and shape of the grooves, the treatment depending on a variety of treatment specifications of the substrate to be treated becomes possible.

According to another preferred aspect of the present invention, by providing the substrate support pin of a predetermined height raised on the surface of the base on which the substrate to be treated is placed, the gap between the surface and the substrate to be treated can be kept constant. By utilizing the constant gap, the gas can be supplied to the treated surface evenly, thereby protecting the untreated surface of the substrate to be treated efficiently.

When, for example, the gas supply is cut off during the substrate treatment, there is a possibility that the substrate to be treated drops to the surface, and sticks to the surface. Then even when the gas supply is resumed, the substrate may remain stuck, making it unable to perform the following process. The substrate to be treated may be damaged, when it is forcibly separated.

By providing the support pin, however, a gap is consistently formed between the substrate to be treated and the placing surface, thereby solving such a problem.

### BRIEF DESCRIPTION OF THE DRAWINGS

FIG. 1 is a sectional view showing a substrate treatment apparatus according to an embodiment of the present invention.

FIGS. 2A through 2C show a structure of a top board. FIG. 2A is a side view, FIG. 2B is an enlarged view of an essential part of a groove portion of FIG. 2A, and FIG. 2C is a sectional view of the essential part taken along the line IIC-IIC of FIG. 2B.

FIG. 3 is an enlarged plan view showing a reverse side of the top board.

FIG. 4 is a sectional view showing a substrate support body of related art.

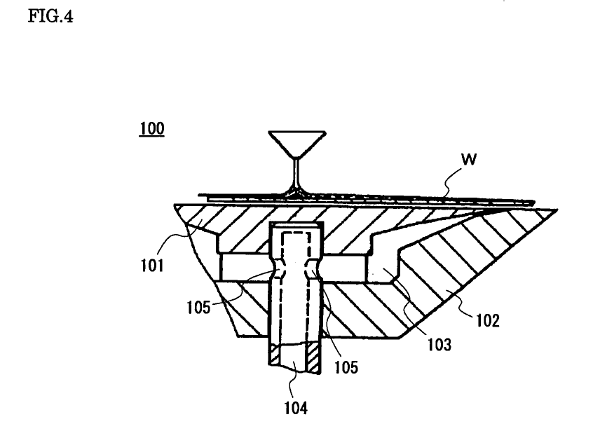

FIG. 5 is a sectional view showing a substrate support body of related art.

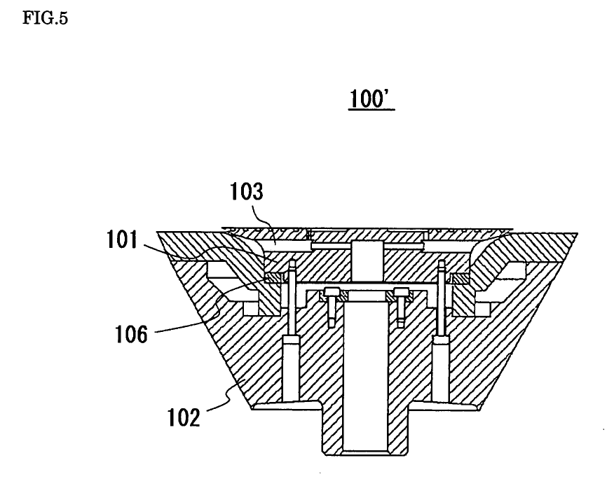

### REFERENCE NUMERALS

W: substrate to be treated (wafer)
1: substrate treatment apparatus
2: (substrate) support body
3: base
5: upper opening
6: concave depression
10: top board
14: blowout nozzle (concave depression)
15: rotating shaft
20: driving means
23: spraying nozzle
30: treatment cup
31: discharge opening
32: multistage cup

### DESCRIPTION OF THE PREFERRED EMBODIMENTS

Hereinafter, preferred embodiments of the present invention will be described with reference to the drawings. The following embodiments are examples of a substrate treatment apparatus to embody the present invention and the invention is not limited by the embodiments. The present invention may be equally applied to other embodiments within the spirit and scope of the appended claims.

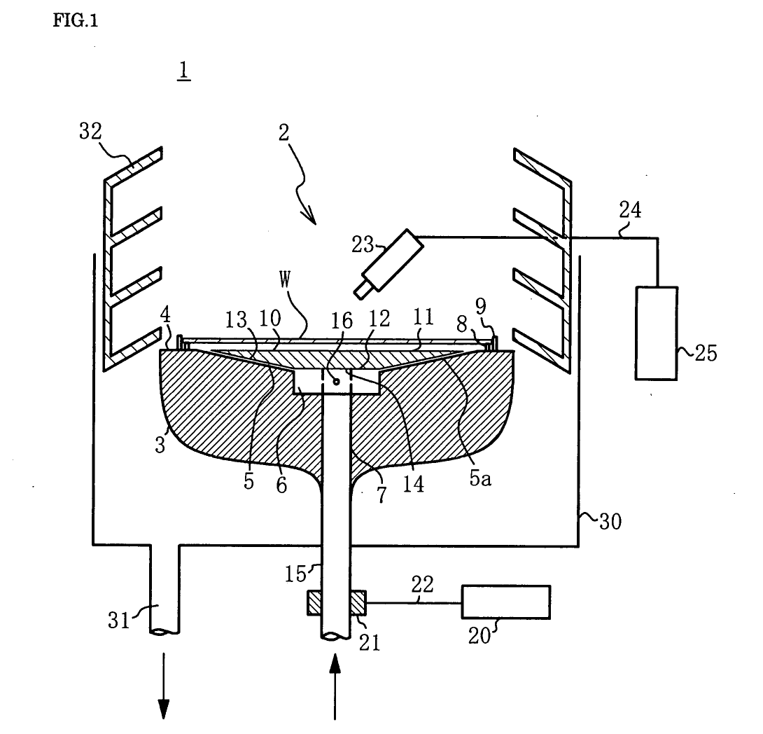

FIG. 1 is a sectional view showing a substrate treatment apparatus according to an embodiment of the invention.

This substrate treatment apparatus 1 comprises a substrate support body (hereinafter, referred to as “support body”) 2 supporting a variety of substrates to be treated, such as a wafer W, and including a blowout nozzle 14 having a blowout hole to blow out gas, a driving means 20 to rotate the support body 2, and a spraying nozzle 23 to drip a treatment liquid to a surface of the wafer W. The support body 2 and the spraying nozzle 23 are contained in a treatment cup 30.

The spraying nozzle 23 is connected to a treatment liquid supply device 25, disposed outside of the treatment cup 30, by a pipe 24, and capable of supplying a predetermined treatment liquid.

A multistage cup 32 capable of moving up and down for collecting the treatment liquid is provided above the treatment cup 30. A discharge opening 31 to discharge the used treatment liquid is provided at the bottom of this treatment cup 30. The discharge opening 31 is connected to a drainage treatment apparatus (not shown) by a pipe.

The support body 2 comprises a circular bowl-shaped base 3 and a top board 10 generally formed in a disk shape, having a longitudinal cross section of an approximately reverse trapezoidal shape. The top board 10 is fitted in an upper opening 5 of the base 3. An outer peripheral surface of the top board 10 and the opening 5 serves as a surface on which the wafer W is placed.

An upper edge of the base 3 has a flat surface 4. A substrate support pin 8 on which the wafer W is placed and a movement restricting pin 9 to prevent horizontal movement of the rotating wafer W are provided on the flat surface 4, so as to come in contact with an outer periphery of the wafer W.

By providing the substrate support pin 8, the wafer W can be prevented from sticking to the surface and becoming difficult to separate. Specifically, when the gas supply is cut off while processing the substrate to be treated, for example, there is a possibility that the substrate (wafer) drops to the surface and sticks to the surface. Then even when the gas supply is resumed, the substrate may remain stuck, making it unable to perform the following process. The substrate to be treated may be damaged, when it is forcibly separated. As a gap is formed between the wafer W and the surface by providing the support pin, such a problem can be solved.

Three or more of the support pin 8 and the restriction pin 9 are preferably provided to the upper edge of the base 3, approximately at equal intervals. The substrate support pin 8 and the movement restricting pin 9 are provided separately here, but may be made as a single pin, for example, an uneven pin with a support portion that is shorter in height.

The base 3 is formed with a concave depression 6 having an opening of a predetermined size and depth at the bottom, and an inclined surface 5a inclined at a predetermined angle, for example, angle θ within a range of 10° to 45° towards the upper opening from the concave depression 6. A preferred angle θ is 12°.

A penetrating hole 7 which penetrates downward is formed at a center of the concave depression 6. By providing the concave depression 6, an open space of a predetermined size is formed between the concave depression 6 and the top board 10, when the top board 10 is fitted to the hollow of the upper opening 5. In the open space, the gas supplied through a rotating shaft during the operation of the apparatus is temporarily stored. The rotating shaft 15 hereinafter described is inserted and fixed to the penetrating hole 7.

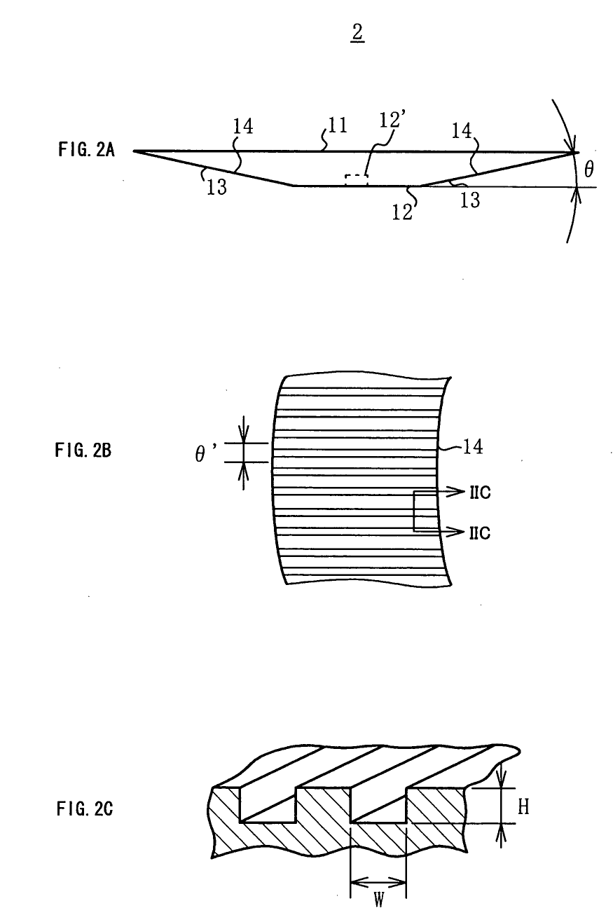

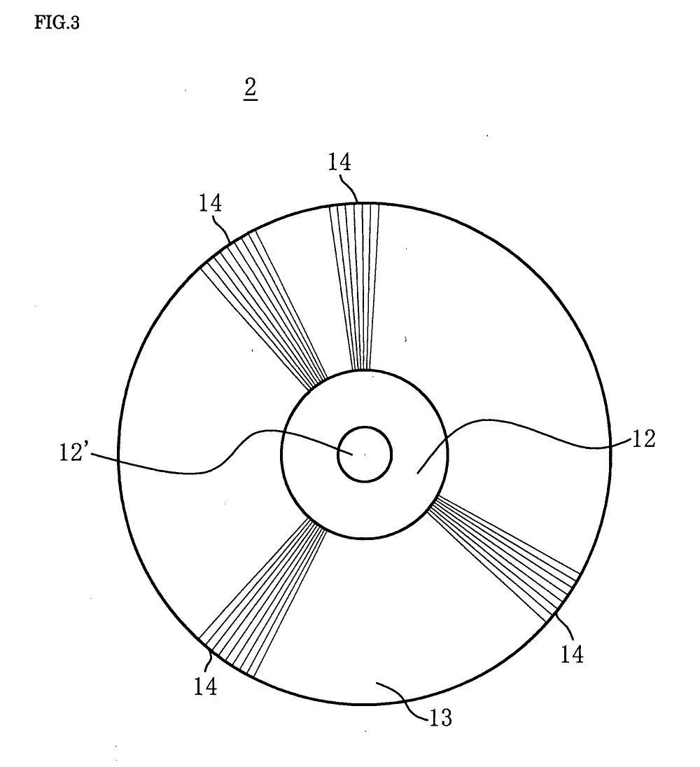

FIGS. 2A through 2C show a structure of the top board. FIG. 2A is a side view, FIG. 2B is an enlarged view of an essential part of a groove portion of FIG. 2A, and FIG. 2C is a sectional view of the essential part taken along the line IIC-IIC of FIG. 2B. FIG. 3 is an enlarged plan view showing a reverse side of the top board.

The top board 10 is generally formed in a disk shape having a predetermined thickness, and a board having longitudinal cross section of approximately reverse trapezoidal shape. The reverse trapezoidal shape, as shown in FIG. 2, has a short undersurface 12, a relatively long top surface 11, and inclined surfaces 13 joining the undersurface 12 and the top surface 11. The short undersurface 12 is fitted to the concave depression 6 of the base 3, and the top surface 11 is fitted to a position parallel to the flat surface 4.

An area of the undersurface 12 is approximately the same as the upper opening of the concave depression 6 of the base 3. A depression 12′ to insert and fix an end of the rotating shaft 15 is formed at a center of the undersurface (this portion is a center of the disk-shape top board). The depression 12′ is a concave depression which does not penetrate the top board 10.

The top surface 11 has a flat surface, and the wafer W is placed so as not to come in contact with the flat surface. Each of the inclined surfaces 13 is formed to incline at a predetermined angle of θ, upward from the undersurface 12. This angle is the same as the angle θ of the above-described inclined surface 5a of the base 3.

As shown in enlargement in FIGS. 2B and 3, a plurality of concave grooves 14 are formed to the inclined surface 13 at an equal angle of θ′, extending radially from the center point of the top board 10 towards the outer periphery.

As shown in FIG. 2C, each concave groove 14 has a predetermined width W and a predetermined depth H. Its angle θ′, width W, and depth H are, for example, θ′=1°, W=0.5 mm and H=0.4 mm. The number of the grooves is 360 at this time. The shape and the number of the concave groove 14 may be changed, for example, to θ′=20, W=1.0 mm, and the number of the grooves to 180.

Without changing the number of the grooves, the depth H may be changed in every other groove. In other words, a deep groove H₁ and a shallow groove H₂ may be provided alternatively. The deep groove H₁, for example, may be 0.5 mm deep, and the shallow groove H₂, for example, may be 0.3 mm deep.

Further, the shape of the grooves is not limited to the above-described concave-shape, but may be changed into other shapes such as rectangular or semicircle, and may be combined with the above-described widths, depths, angles and numbers of the grooves.

By changing the shapes and the number of the grooves like this, a blowout nozzle to achieve a desired result on a reverse side of a wafer W can be formed.

In the above-described embodiment, the concave grooves are provided at the top board 10, but similar grooves may be provided at the inclined surface 5a of the base 3. The concave grooves may be provided at both the top board 10 and the base 3. In a case when the concave grooves are provided at both the top board 10 and the base 3, both grooves are to be disposed so as to oppose to each other, or placed alternatively. This enables an increase in the number of the grooves and an amount of gas blown out from the grooves.

The rotating shaft 15 is a hollow cylinder. A plurality of holes 16 which spray gas to an outer peripheral surface of the cylinder are formed at an end of the cylinder's portion bonded to the top board 10. The rotating shaft 15 is inserted through the penetrating hole 7 of the base 3, and the shaft's end is inserted into the concave depression 12′ at a center of the top board 10. After being inserted through the penetrating hole 7 and into the concave depression 12′, the top board 10 and the base 3 are integrally fixed to the rotating shaft 15 with a predetermined fixing means.

The rotating shaft 15 fixed to the base 3 mounts a pulley 21 and the like under the base 3 and is linked to a driving means 20 such as a motor by a power transmission means 22 such as a belt. The shaft is rotated by the power from the driving means 20, and rotates the support body 2 at a predetermined rotation speed.

A gas such as compressed air or nitrogen gas, is supplied through the rotating shaft 15, and supplied to an open space through the holes 16 at its end.

A wafer processing method using the substrate treatment apparatus 1 will be described below.

First, by using a transport mechanism, which is not shown, one wafer W is placed on the support pin 8 of the support body 2. Next, by activating the driving means 20, the support body 2 is rotated via the rotating shaft 15 to drip a cleaning liquid onto the upper surface of the rotating wafer W from the spraying nozzle 23. The spraying nozzle 23 sprays the treatment liquid in a reciprocating manner linearly in a radial direction of the wafer W, or so as to draw an arc passing through the center of the wafer W, by a transport means which is not shown. This enables homogeneous cleaning. The cleaning liquid dripped to the surface of the wafer W runs toward the outer periphery on the wafer W by centrifugal force, and is blown out from the outer periphery of the wafer W. The wafer W tends to move in a lateral direction during its rotation, but this movement is prevented by the restricting pin 9.

At the same time as or before placing the wafer W, compressed gas such as nitrogen gas is supplied in the concave depression 6 via the hollow rotating shaft 15 from a compression tank which is not shown. The gas supplied in the concave depression 6 is temporary stored in the open space and is blown out to the outer peripheral portion of the reverse side of the wafer W, through the plurality of concave grooves 14, in other words, a gas blowout nozzle, formed at the reverse side of the top board 10.

Therefore, as the gas is blown out in a direction from the center of the wafer W towards the outer periphery, the cleaning liquid is prevented from going around to the reverse side of the wafer W, so the untreated surface (reverse side) will not be contaminated by the used cleaning liquid.

The support body 2 is disposed in the treatment cup 30, and the multistage cup 32 capable of moving up and down is disposed at a position near the outer periphery of the flat surface 4 of the support body 2, to collect the treatment liquid supplied from the spraying nozzle 23. In addition, by moving the multistage cup 32 up and down by a driving means, which is not shown, depending on the type of the treatment liquid supplied from the spraying nozzle 23, the treatment liquid is collected by a collecting portion (not shown) connected to each stage of the multistage cup 32 with respect to each treatment liquid. The discharge opening 31 discharges unnecessary liquid from the treatment cup 30 during maintenance and trouble shooting.

1. A substrate treatment apparatus, comprising:
a substrate support body on which a substrate to be treated is placed for performing surface treatment by dripping a treatment liquid on a surface of said substrate while rotating said substrate support body, said substrate support body including:
a circular bowl-shaped base;
a top board generally formed in a disk-shape, having a longitudinal cross section of reverse trapezoidal shape, and fitted to an upper opening of said base; and
a hollow rotating shaft provided to said base or said top board at its rotating axis;
a gas blowout nozzle including a plurality of slit-like grooves radially extending from said hollow rotating shaft to outside being formed in at least one surface selected from a contact surface of said top board and an upper opening contact surface of said base brought into contact with each other by said fitting.

2. The substrate treatment apparatus according to claim 1, wherein said slit-like grooves are formed with any one of a concave groove, a semicircle groove or a square groove, and have a predetermined width and depth.

3. The substrate treatment apparatus according to claim 2, wherein said slit-like grooves are formed with a first groove and a second groove with different widths and depths, and said first groove and second groove are arranged alternatively.

4. The substrate treatment apparatus according to claim 1, wherein said substrate support body is a substrate support pin of a predetermined height raised on a surface of said base on which said substrate to be treated is placed.
